(19) United States
(12) Patent Application Publication
(10) Pub. No.: US 2011/0222367 A1
(43) Pub. Date: Sep. 15, 2011

(54) Flexible Touchpad for a Kitchen Appliance

(75) Inventor: Michael W. ALLEN, Glen Allen, VA (US)

(73) Assignee: HAMILTON BEACH BRANDS, INC., Glen Allen, VA (US)

(21) Appl. No.: 13/048,066

(22) Filed: Mar. 15, 2011

Related U.S. Application Data
(60) Provisional application No. 61/313,940, filed on Mar. 15, 2010.

(51) Int. Cl. B01F 13/00; B32B 3/30; B32B 3/24

(52) U.S. Cl. 366/206; 428/156; 428/138

(57) ABSTRACT

A flexible touchpad for a kitchen appliance includes a first surface having at least one button feature integrally molded therein and extending outwardly in a first direction beyond a surrounding portion of the first surface. An opposing second surface has at least one post extending outwardly in a second direction beyond a surrounding portion of the second surface. The at least one post defines a first end, an opposing second free end and a longitudinal axis extending therebetween. The longitudinal axis is generally aligned with the at least one button feature.

### CROSS-REFERENCE TO RELATED APPLICATIONS

The present application claims the benefit of U.S. Provisional Patent Application No. 61/313,940, filed Mar. 15, 2010 and entitled “Kitchen Appliance With A Flexible Touchpad.”

### BACKGROUND OF THE INVENTION

The present invention relates generally to a user interface for an appliance and, more particularly, to a flexible touchpad that surrounds or encloses at least a portion of at least one button or other sensitive structure of a kitchen appliance and allows a user to effectuate operation of the button.

Kitchen appliances and other similar electrical or mechanical devices generally include one or more buttons or actuators to effectuate operation of a motor therein. At least a portion of conventional buttons extend outwardly beyond an outer surface of the appliance and are selectively depressible to actuate the motor. It can be time consuming and/or difficult to clean between a row or plurality of conventional buttons due to the gaps, spaces or crevices formed between the buttons and the outer surface of the appliance. Also, conventional buttons are often not aesthetically pleasing due to their distinct or awkward shape that may disrupt the smooth lines or curves of the appliance. Further, by extending outwardly beyond the outer surface of the appliance, conventional buttons are susceptible to being inadvertently hit or pushed out of alignment, or even snapped or broken.

Therefore, it would be desirable to provide a kitchen appliance with one or more actuator buttons that are entirely or substantially located within the outer surface or housing of the appliance. Specifically, it would be desirable to provide an aesthetically-pleasing and flexible touchpad that generally covers or surrounds one or more buttons located entirely or substantially within the outer surface of the appliance. Furthermore, it would be desirable to fixedly attach at least a portion of the touchpad to at least one of the buttons of the appliance such that selective depression of the respective portion of the touchpad depresses the respective button. The present invention accomplishes the above objectives.

### BRIEF SUMMARY OF THE INVENTION

Briefly stated, one aspect of a preferred embodiment of the present invention is directed to a flexible touchpad for a kitchen appliance including a first surface having at least one button feature integrally molded therein and extending outwardly in a first direction beyond a surrounding portion of the first surface. An opposing second surface has at least one post extending outwardly in a second direction beyond a surrounding portion of the second surface. The at least one post defines a first end, an opposing second free end and a longitudinal axis extending therebetween. The longitudinal axis is generally aligned with the at least one button feature.

In another aspect, a preferred embodiment of the present invention is directed to a flexible touchpad for a kitchen appliance including a first surface having at least one button feature integrally molded therein and extending outwardly in a first direction beyond a surrounding portion of the first surface. An opposing second surface has at least one post extending outwardly in a second direction beyond a surrounding portion of the second surface. The at least one post defines a first end, an opposing second free end and a longitudinal axis extending therebetween. The longitudinal axis is generally aligned with the at least one button feature. The at least one post includes a hole for receiving at least a portion of an actuator button of the kitchen appliance.

In yet another aspect, a preferred embodiment of the present invention is directed to a kitchen appliance including a base having an exterior surface defining an opening therein. At least one actuator button is located at least partially within the base. A flexible touchpad is sized and shaped to cover the opening and enclose the at least one actuator within the base. The touchpad includes a first surface having at least one button feature integrally molded therein and extending outwardly in a first direction beyond a surrounding portion of the first surface. An opposing second surface has at least one post extending outwardly in a second direction beyond a surrounding portion of the second surface. The at least one post defines a first end, an opposing second free end and a longitudinal axis extending therebetween. The longitudinal axis is generally aligned with the at least one button feature. The at least one post includes a hole for receiving at least a portion of an actuator button of the kitchen appliance.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a front left perspective view of a kitchen appliance in accordance with a first preferred embodiment of the present invention;

FIG. 2 is an enlarged left side perspective view of a portion of the kitchen appliance shown in FIG. 1;

FIG. 3 is a partially exploded perspective view of a portion of the kitchen appliance shown in FIG. 1;

FIG. 4 is an enlarged partially exploded perspective view of a portion of the kitchen appliance shown in FIG. 1;

FIG. 5 is an enlarged top perspective view of a touchpad of the kitchen appliance shown in FIG. 1;

FIG. 6 is a front elevation view of the touchpad shown in FIG. 5;

FIG. 7 is a bottom perspective view of the touchpad shown in FIG. 5;

FIG. 8 is a bottom plan view of the touchpad shown in FIG. 5;

FIG. 9 is an enlarged cross-sectional perspective view of a portion of the touchpad and the kitchen appliance shown in FIG. 1; and

FIG. 10 is an enlarged cross-sectional perspective view of a portion of a touchpad and a kitchen appliance in accordance with a second preferred embodiment of the present invention.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the kitchen appliance in accordance with the present invention, and designated parts thereof. Unless specifically set forth herein, the terms “a”, “an” and “the” are not limited to one element but instead should be read as meaning “at least one.” The terminology includes the words noted above, derivatives thereof and words of similar import.

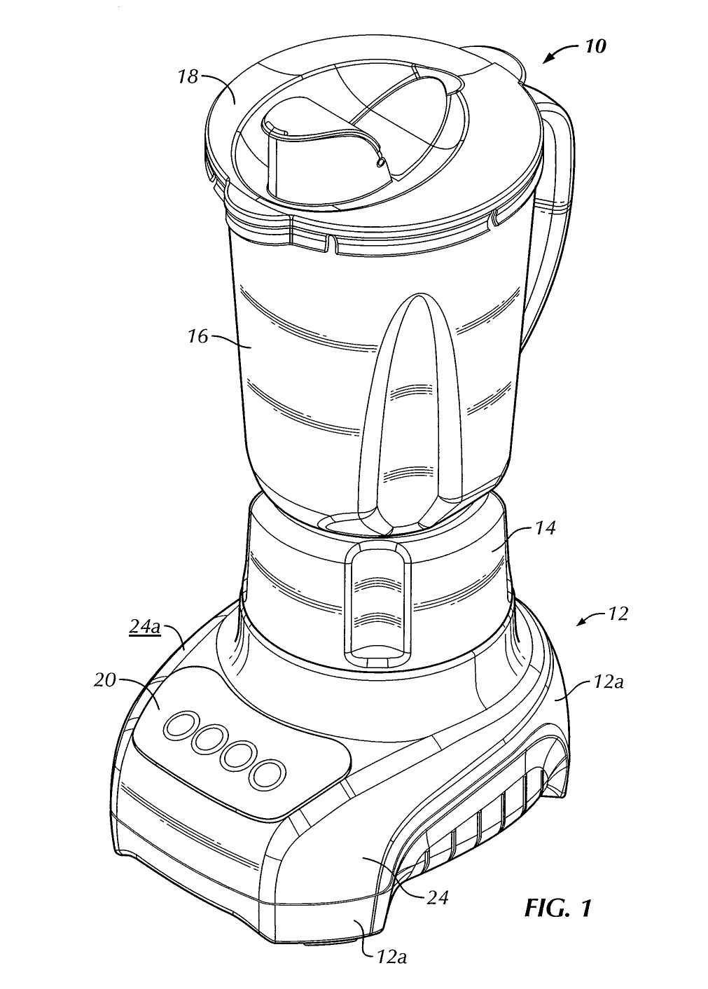

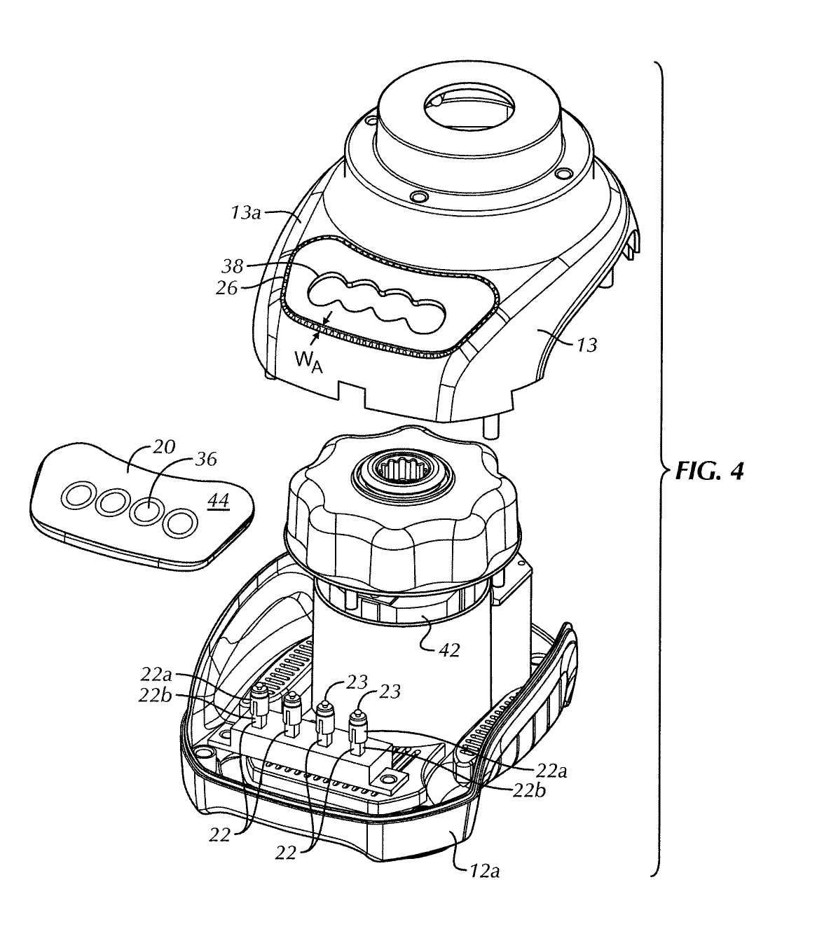

Referring to the drawings in detail, wherein like numerals indicate like elements throughout, there is shown in FIGS. 1-9 a kitchen appliance, generally designated 10, in accordance with a first preferred embodiment of the present invention. The kitchen appliance 10 is preferably a blender or other mixing device, but the present invention is not so limited. For example, the kitchen appliance 10 may be a food chopper or processor, a slow cooker, a toaster, a toaster oven, or any other device having one or more buttons to control operation of a motor 42 (FIG. 4) therein or any other operational feature.

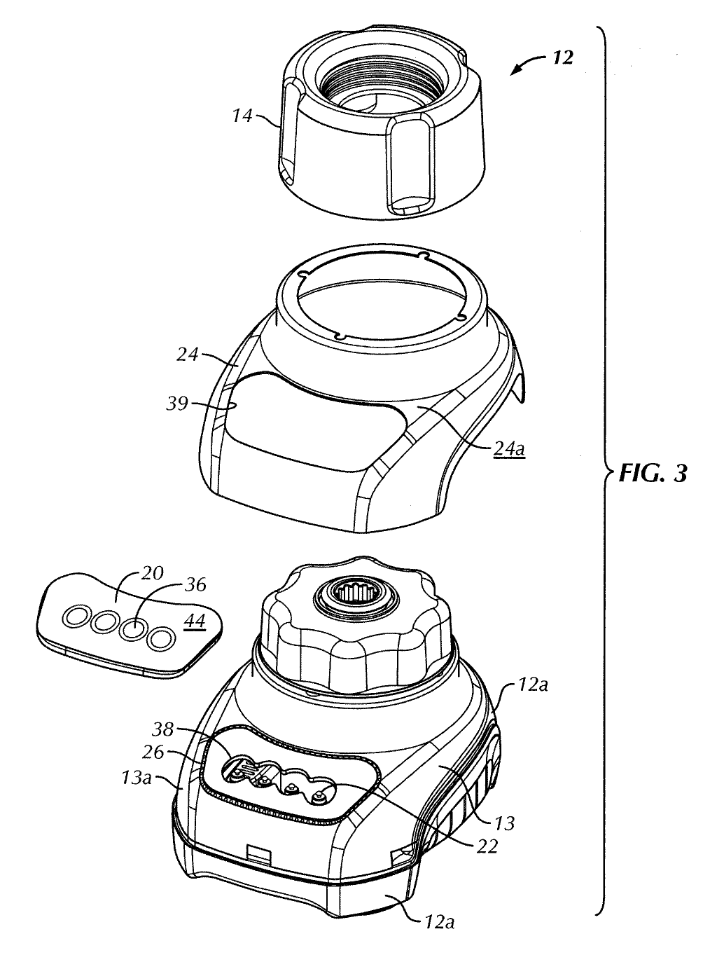

Referring to FIGS. 1-4, the kitchen appliance 10 preferably includes a base 12 enclosing the motor 42 (FIG. 4) and a collar 14 removably mountable to a portion of a top surface of the base 12. The base 12 preferably includes a housing 12a that rests directly on a support surface (not shown), such as a table top or countertop, a lower cover 13 removably attachable to the housing 12a to generally enclose the motor 42 therebetween, and an upper cover 24 removably attachable to a top surface of the lower cover 13 (see FIG. 3). A container or jar 16 for holding foodstuff (not shown) to be blended is preferably removably mountable to a top surface of the collar 14. However, the jar 16 may be removably mountable directly to the base 12, and the collar 14 may be omitted. A lid 18 is preferably removably mounted to an upper opening of the jar 16 to enclose the foodstuff therein.

As shown in FIGS. 3 and 4, a recessed area or endless (i.e., continuous) groove 26 is preferably formed in an exterior or outer surface 13a of the lower cover 13. The recessed area 26 has a predetermined width W_{A} (FIG. 4) that extends around an entire periphery thereof. The recessed area 26 preferably surrounds an entire elongated opening 38 that extends completely through the lower cover 13. However, the recessed area 26 may only surround a portion of the elongated opening 38. For example, two separate and spaced-apart recessed areas 26 (not shown) may be formed on opposing sides of the elongated opening 38. The upper cover 24 also preferably includes an opening 39 (FIG. 3) that extends completely therethrough. As shown in FIG. 3, the opening 39 of the upper cover 24 is preferably sized and shaped to generally, if not exactly, match the size and shape of an outer periphery of the recessed area 26 of the lower cover 13.

Although FIG. 3 shows the upper cover 24 being removably mountable to the lower cover 13 and/or a top surface of the base 12, the upper cover 24 may not be a necessary component of the present invention. In other words, the base 12 may be formed of only the housing 12a and the lower cover 13. Alternatively, the upper cover 24 may be integrally and permanently attached to the lower cover 13 and/or the base 12. In a fully assembled configuration of the kitchen appliance (FIG. 1), it is preferred that the entire recessed area 26 is located below or recessed with respect to an adjacent outer surface 24a of the upper cover 24 when the upper cover 24 is attached to the lower cover 13 and/or the base 12.

Referring specifically to FIGS. 3 and 4, at least one actuator button or switch 22 is preferably located entirely or at least substantially within the outer surface of the base 12 and/or the outer surface 24a of the upper cover 24. As shown in FIG. 3, it is preferred that no portion of the at least one button 22 extends to or beyond the outer surface 24a of the upper cover 24 and/or the base 12. Further, it is preferred that no portion of the at least one selectively depressible button 22 extends beyond the outer surface of the lower cover 13. The elongated opening 38 preferably provides access to the at least one button 22. The at least one button 22 is preferably operatively connected to the motor 42 and allows a user to control operation of the motor 42 and, thus, operation of the kitchen appliance 10.

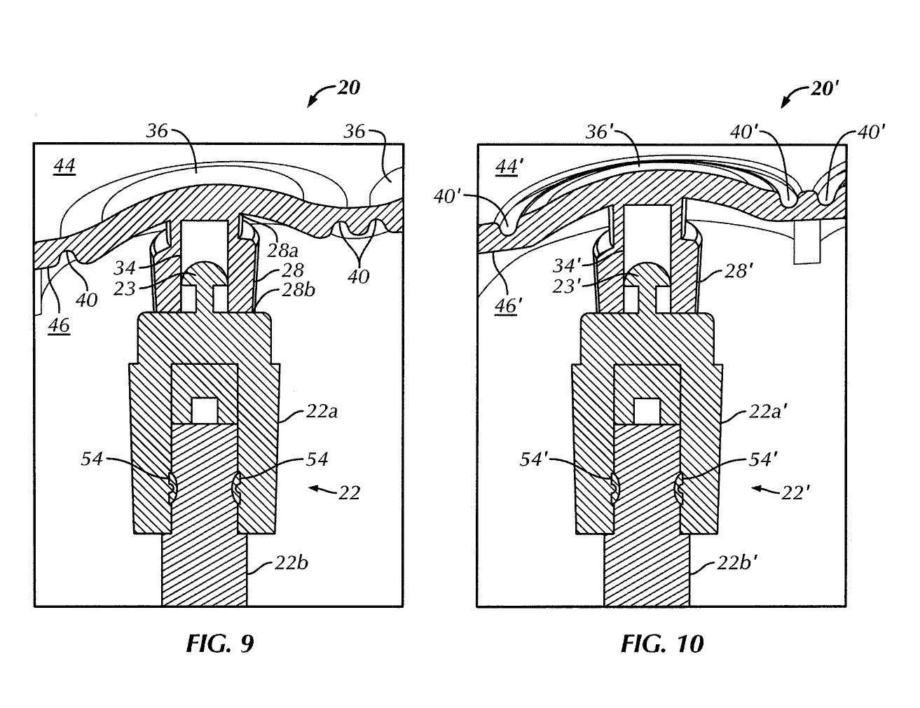

It is preferred that the kitchen appliance 10 includes a row of four, for example, laterally spaced-apart mechanical actuator buttons 22. However, the kitchen appliance 10 is not so limited, as the present invention is applicable to any number of actuation buttons. As shown in FIGS. 4 and 9, each button 22 may include a lower portion 22b having a generally square cross-sectional area, when viewed from above, and a connector or upper portion 22a that generally surrounds and/or engages at least a top segment of the lower portion 22b (see FIG. 9). As shown in FIG. 9, an interior surface or sidewall of the upper portion 22a and/or an exterior surface or sidewall of the lower portion 22b may include one or more detents or projections 54, which preferably creates a engagement or connection between the upper and lower portions 22a, 22b. Alternatively, the detent(s) or projection(s) 54 may be replaced by or substituted for any of a variety of connections, such as adhesive or soldering.

Alternatively, each button 22 may include only a single lower portion 22b that is greater in height or length that the lower portion 22b shown in FIGS. 4 and 9, such that the lower portion 22b extends to and engages at least a portion of the flexible user interface, as described in detail below. In other words, the upper portion 22a may not be a necessary component of any button 22. It is preferred that the button(s) 22 and/or the kitchen appliance 10 generally operates in a similar manner to kitchen appliances found in the prior art. Therefore, a detailed description of the operation of the button(s) 22 and/or the kitchen appliance 10 is omitted herein for convenience and the sake of brevity, and is not limiting.

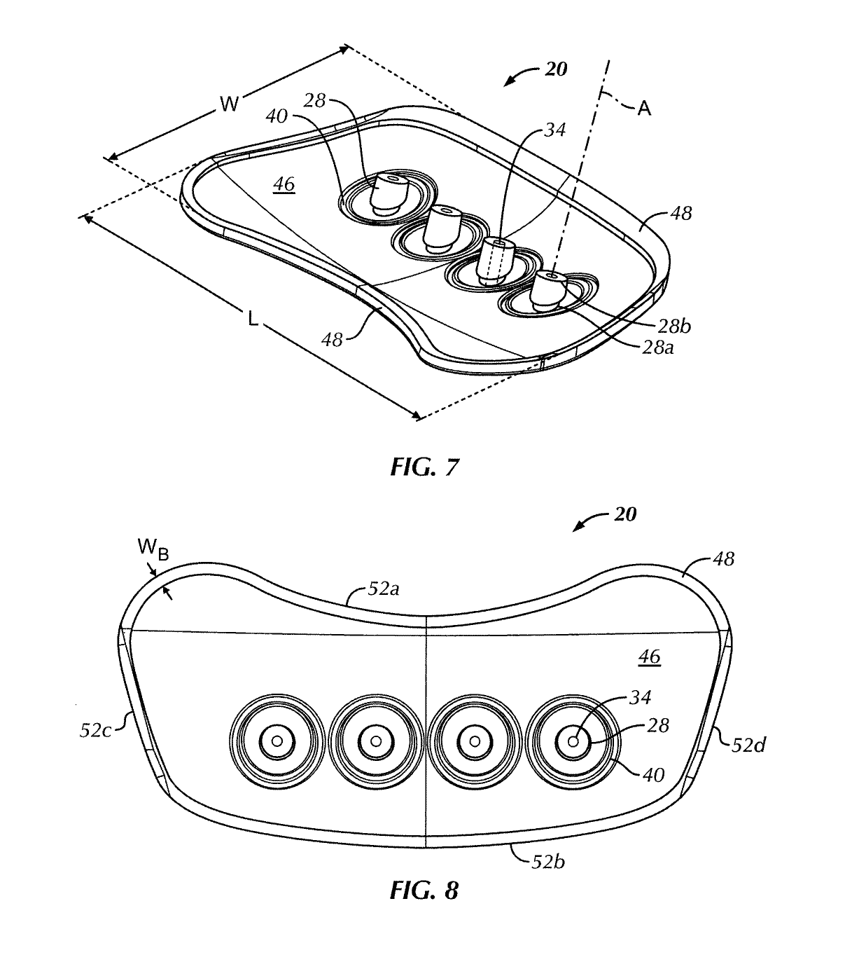

Referring to each of FIGS. 1-9, the kitchen appliance 10 preferably includes a flexible user interface or touchpad 20 that covers at least one and preferably all four of the spaced-apart buttons 22 of the base 12. The touchpad 20 is preferably complementarily sized and shaped to securely fit within at least a portion of the recessed area 26 and cover both the opening 38 and all of the buttons 22. As shown in FIG. 7, a length L of the touchpad 20 is preferably greater than a width W thereof, and the length L is preferably approximately two times greater than the width W. A first, top or outer surface 44 of the touchpad 20, which is preferably at least slightly or generally convexly shaped (see FIG. 6), is preferably generally coplanar with the entire surrounding adjacent portion of the outer surface 24a of the upper cover 24 and/or the base 12 when the touchpad 20 is attached to the base 12. The touchpad 20 is preferably formed of a material that maintains flexibility and durability throughout the life of the kitchen appliance 10. Preferably, the touchpad 20 is formed of an elastomer material, such as rubber, and/or a flexible polymer material, so that the touchpad 20 has noticeable elasticity, give or spring-back when manipulated by a user.

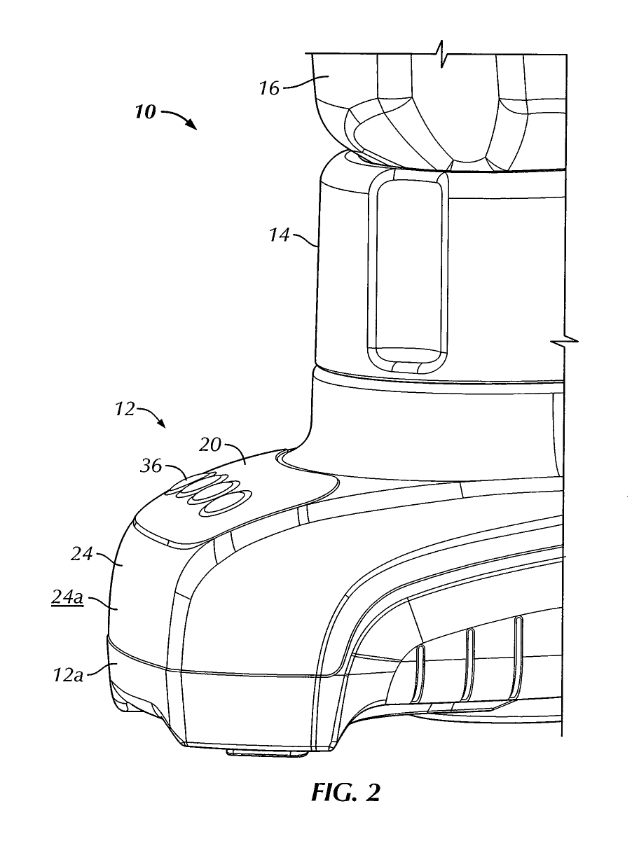

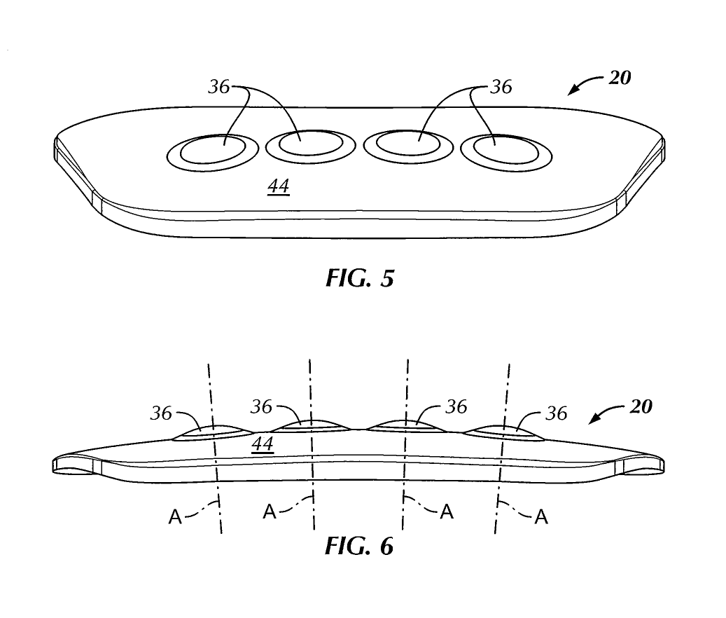

Referring now to FIGS. 5, 6 and 9, the top surface 44 of the touchpad 20 includes at least one and preferably includes four laterally spaced-apart button features 36 that correspond to the spacing and location of the buttons 22. Thus, when the touchpad 20 is fixed to the base 12, as described in detail below, one button feature 36 is preferably located directly above each button 22. Each button feature 36 is preferably generally in the shape of a dome, such that each button feature 36 preferably extends outwardly away or upwardly from the top surface 44 of the touchpad 20 in a first direction beyond a surrounding portion of the top surface 44. Each button feature 36 is also preferably integrally and unitarily formed or molded with the top surface 44 of the touchpad 20. In the first preferred embodiment, each button feature 36 is shown as being circular when viewed from above (FIG. 1) and slightly raised with respect to the remaining portions of the touchpad 20 (see FIGS. 2 and 6). However, the button features 36 are not so limited, as the button features 36 may be formed in any of a variety of shapes and/or sizes.

As shown in FIGS. 7-9, at least one and preferably four spaced-apart posts 28 preferably extend generally perpendicularly or outwardly in an opposing second direction from an opposing second, bottom or inner surface 46 of the touchpad 20. More specifically, each post 28 preferably has a first end 28a integrally molded with the inner surface 46, an opposing second free end 28b, and a longitudinal axis A that extends therebetween. The longitudinal axis A preferably extends generally perpendicular to a plane defined by the inner surface 46 at a point where the respective post 28 extends from. However, it is understood that the longitudinal axis A of each post 28 may extend at an angle of approximately forty-five degrees (45°), for example, from at least a portion of the inner surface 46 of the touchpad 20, depending upon the shape or contour of the touchpad 20 and the location of the actuator button(s) 22.

As shown in FIGS. 7 and 8, the inner surface 46 is generally concave, and may include a raised boarder 48 that extends in the second direction around the entire periphery of the inner surface 46. As shown in FIG. 8, the raised boarder 48 has a predetermined width W_{B}, which is preferably generally equal to or slightly larger than the predetermined width W_{A} (FIG. 4) of the recessed area 26. As a result, at least a portion of the raised boarder 48 may be inserted into at least a portion of the recessed area 26, which preferably creates a friction fit therebetween to generally hold the touchpad 20 in place on the lower cover 13. In such an embodiment, the upper cover 24 may then placed on top of or over the lower cover 13, such that the opening 39 of the upper cover 24 generally surrounds the touchpad 20 to create an aesthetically pleasing appearance in the fully assembled configuration (FIG. 1). Additionally or alternatively, an adhesive, such as a glue or other epoxy, may be used to attach the touchpad 20 to the lower cover 13 and/or any other portion of the base 12. In an alternative embodiment, the touchpad 20 may be molded as part of the lower cover 13 and/or any other portion of the base 12, such that the touchpad 20 and any portion of the base 12 are a single, integral, and unitary component.

Each button feature 36 is preferably at least generally aligned with one of the posts 28, such that the longitudinal axis A of each post 28 extends generally through a geometric center of one of the button features 36. The posts 28 are preferably aligned in a linear row generally across a width of the touchpad 20, but the posts 28 are not so limited. Each post 28 is preferably directly attached to a respective button 22, such that at least a portion of each button 22 is inserted into a portion of a respective post 28. More specifically, at least a portion of a bulbous tip 23 (FIG. 4) of each upper portion 22a of each button 22 is inserted into at least a portion of each post 28. Alternatively, as described above, the bulbous tip 23 may be a portion of the lower portion 22b of each button 22.

Each post 28 is preferably integrally and unitarily formed or molded with the inner surface 46 of the touchpad 20 and is preferably sized and shaped to attach and/or receive at least a portion of one of the four mechanical buttons 22. Specifically, as seen in FIGS. 7 and 8, each post 28 is preferably cylindrical, circular in cross-section and preferably includes a hole or passageway 34 therein, which allows each post 28 to fit onto and generally lock with at least a portion of one of the four buttons 22. As shown in phantom in FIGS. 7, 9 and 10, the hole 34 may extend from a bottom-most or distal point or surface of the post 28 (i.e., the second free end 28b) to the bottom surface 46 of the touchpad 20 (i.e., the first end 28a) along the longitudinal axis A. In other words, at least a portion of each button 22, such as the bulbous tip 23, is inserted into a portion of each post 28 to create a firm connection, such as a friction fit, between each button 22 and respective post 28.

As shown in FIGS. 7 and 9, a portion of each post 28 proximate the inner surface 46 of the touchpad 20 preferably has a reduced diameter as compared to a more distal portion of each post 28. In other words, an exterior surface of the first end 28a of each post 28 preferably has a smaller circumference or perimeter than the second free end 28b thereof. Further, a circular indentation or depression 40 preferably surrounds the entire perimeter or circumference of each button feature 36 on the inner surface 46 of the touchpad 20. The depression 40 is preferably concavely shaped when viewed from the side (FIG. 9). The depression 40 provides increased flexibility to the respective button feature 36, which allows a particular button feature 36 to move with respect to the remaining portions of the touchpad 20.

Referring to FIG. 8, the touchpad 20 preferably includes a generally arcuate and/or concave top sidewall 52a, which is preferably proximate or adjacent to the collar 14 when the kitchen appliance 10 is in a fully assembled configuration (see FIG. 1). An opposing bottom sidewall 52b of the touchpad 20 is preferably only slightly arcuate and/or convex. Left and right side sidewalls 52c, 53d of the touchpad 20 are preferably straight or linear. The size and shape of the touchpad 20 allows the touchpad 20 to conform to or blend in with the outer surface 24a of the upper cover 24 and/or the base 12 when the kitchen appliance 10 is in the fully assembled configuration.

In operation, since the touchpad 20 and buttons 22 are preferably fixedly connected together by the posts 28, a respective button feature 36 preferably moves (i.e., inwardly or outwardly, up or down) with movement of a respective button 22. For example, the two center buttons 22 may be designed to remain in the depressed position (i.e., latch down) when pressed by a user. As a result, the respective button features 36 for these two center buttons 22 preferably will also be held down to indicate to the user that the function is activated, while the two outer buttons 22 remain in the extended position. When the respective button(s) 22 is/are released by the user and rise or extend toward the outer surface 24a of the upper cover 24 and/or the base 12, the respective button feature(s) 36 also rise or extend with the respective button(s) 22. Thus, it is preferred that each button feature 36 of the flexible touchpad 20 is directly connected to one button 22, such that each button feature 36 moves with movement of its respective button 22.

Referring to FIG. 10, a portion of a touchpad 20′ in accordance with a second preferred embodiment of the present invention is shown, including like reference numerals to indicate like elements and a prime symbol (′) distinguishing the reference numerals of the second preferred embodiment from the first preferred embodiment. The touchpad 20′ of the second preferred embodiment is substantially similar to that of the first preferred embodiment described above. Specific similarities between the embodiments may be omitted herein for the sake of brevity and convenience, and therefore, is not limiting.

Similar to the first preferred embodiment, the second preferred embodiment includes at least one button 22′ to selectively effectuate operation of a motor (not shown). Further, the touchpad 20′ is preferably formed of a flexible material and includes a post 28′ extending from a bottom or inner surface 46′ thereof to directly connect at least a portion of the touchpad 20′ directly to the at least one button 22′. In the second preferred embodiment, at least one circular indentation or depression 40′ is located on a top or outer surface 44′ of the touchpad 20′, instead of on the bottom or inner surface 46′, for better visual appearance and identification of a button features 36′ on the outer surface 44′. In other words, the depression 40′ provides an aesthetically pleasing visual demarcation between each button feature 36′ and the remaining portion of the exterior surface 44′ of the touchpad 20′.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A flexible touchpad for a kitchen appliance, the touchpad comprising:
a first surface having at least one button feature integrally molded therein and extending outwardly in a first direction beyond a surrounding portion of the first surface; and
an opposing second surface having at least one post extending outwardly in a second direction beyond a surrounding portion of the second surface, the at least one post defining a first end, an opposing second free end and a longitudinal axis extending therebetween, the longitudinal axis being generally aligned with the at least one button feature.

2. The touchpad according to claim 1, wherein the at least one post includes a hole for receiving at least a portion of an actuator button of the kitchen appliance.

3. The touchpad according to claim 1, further comprising:
at least two laterally spaced-apart button features extending outwardly in the first direction beyond a surrounding portion of the first surface; and
at least two laterally spaced-apart posts extending outwardly in the second direction beyond a surrounding portion of the second surface.

4. The touchpad according to claim 1, wherein the first surface is generally convex and the second surface is generally concave.

5. The touchpad according to claim 1, wherein the touchpad is constructed of a material selected from the group consisting of an elastomer and polymer material.

6. The touchpad according to claim 1, further comprising:
a depression surrounding an entire periphery of the at least one button feature on the first surface.

7. The touchpad according to claim 1, further comprising:
a depression surrounding an entire periphery of the at least one post on the second surface.

8. The touchpad according to claim 1, wherein the first end of the at least one post includes a reduced diameter compared to the second free end thereof.

9. The touchpad according to claim 1, wherein the hole of the at least one post generally extends from the second free end of the at least one post to the first end thereof.

10. The touchpad according to claim 1, wherein the post is integrally molded in the second surface.

11. A flexible touchpad for a kitchen appliance, the touchpad comprising:
a first surface having at least one button feature integrally molded therein and extending outwardly in a first direction beyond a surrounding portion of the first surface; and
an opposing second surface having at least one post extending outwardly in a second direction beyond a surrounding portion of the second surface, the at least one post defining a first end, an opposing second free end and a longitudinal axis extending therebetween, the longitudinal axis being generally aligned with that at least one button feature, the at least one post including a hole for receiving at least a portion of an actuator button of the kitchen appliance.

12. A kitchen appliance comprising:
a base having an exterior surface defining an opening therein;
at least one actuator button located at least partially within the base; and
a flexible touchpad size and shaped to cover the opening and enclose the at least one actuator button within the base, the touchpad including a first surface having at least one button feature integrally molded therein and extending outwardly in a first direction beyond a surrounding portion of the first surface, an opposing second surface having at least one post extending outwardly in a second direction beyond a surrounding portion of the second surface, the at least one post defining a first end, an opposing second free end and a longitudinal axis extending therebetween, the longitudinal axis being generally aligned with the at least one button feature, the at least one post including a hole for receiving at least a portion of the at least one actuator button of the kitchen appliance.

13. The kitchen appliance according to claim 12, further comprising:
a motor at least partially enclosed by the base; and
a jar removably mountable to the base.

14. The kitchen appliance according to claim 13, further comprising:
a collar removably mountable to at least a portion of the base, the jar being mountable on the collar.

15. The kitchen appliance according to claim 12, further comprising:
a recessed area formed in the exterior surface of the base, the recessed area surrounding the opening, an outer periphery of the flexible touchpad being positioned within the recessed area.

16. The kitchen appliance according to claim 12, wherein the first surface of the touchpad surrounding the at least one button feature is generally coplanar with the exterior surface of the base surrounding the recessed area.

17. The kitchen appliance according to claim 12, further comprising:
four laterally spaced-apart actuator buttons located at least partially within the base.

18. The kitchen appliance according to claim 17, wherein the touchpad further comprises:
four laterally spaced-apart button features extending outwardly in the first direction beyond a surrounding portion of the first surface; and
four laterally spaced-apart posts extending outwardly in the second direction beyond a surrounding portion of the second surface,
wherein each post engages at least a portion of one of the four actuator buttons within the base.
